(19) United States
(12) Patent Application Publication
(10) Pub. No.: US 2026/0132805 A1
(43) Pub. Date: May 14, 2026

(54) FLOW STABILIZING VALVE AND FLOW STABILIZING WATER HYDROGRAPHIC SYSTEM USING THE SAME

(71) Applicant: ZHONG SHAN DIPPERS ELECTRIC CO., LTD., Zhongshan (CN)

(72) Inventors: Rui WAN, Zhongshan (CN); Zhenzhen QIAO, Zhongshan (CN)

(21) Appl. No.: 19/444,145

(22) Filed: Jan. 8, 2026

Related U.S. Application Data
(63) Continuation of application No. PCT/CN2023/135867, filed on Dec. 1, 2023.

(30) Foreign Application Priority Data
Jul. 25, 2023 (CN) 202310921455.6

(51) Int. Cl. F15D 1/02

(52) U.S. Cl. CPC F15D 1/02

(57) ABSTRACT

A flow stabilizing valve and a water flow stabilization system using the same are disclosed. The flow stabilizing valve includes a valve core, a valve sleeve, and a valve housing. The valve core includes a pressure stabilizing water passage. The valve core is disposed within the valve sleeve and forms a water chamber jointly with the valve sleeve. The valve sleeve is disposed within the valve housing and forms an air chamber jointly with the valve housing. The valve sleeve is capable of elastic deformation. When water flows from the pressure stabilizing water passage into the water chamber, the valve sleeve expands towards the air chamber and maintains a compressing force on the water, thereby creating a tendency for the water to flow back from the water chamber to the pressure stabilizing water passage as the valve sleeve contracts and resets.

### CROSS-REFERENCE TO RELATED APPLICATIONS

This application is a United States national stage application of co-pending International Patent Application Number PCT/CN2023/135867, filed Dec. 1, 2023, which claims the priority and benefit of Chinese patent application number 202310921455.6, entitled “Flow Stabilizing Valve and Flow Stabilizing Water Hydrographic System Using the Same” and filed Jul. 25, 2023, with China National Intellectual Property Administration, the entire contents of which are incorporated herein by reference.

### TECHNICAL FIELD

The present disclosure relates to a flow stabilizing valve in a coffee machine and a water flow stabilization system using the same.

### BACKGROUND

A coffee machine is a device that grinds, brews, and prepares coffee from coffee beans, wherein the pressure and water required for coffee extraction are provided by an electromagnetic pump. Since the water supply from the electromagnetic pump is pulsatile (i.e., intermittent), the water pressure inside the pipeline increases when the electromagnetic pump supplies water and decreases when the electromagnetic pump stops supplying water. This results in unstable water pressure within the pipeline, making it difficult for the pipeline pressure to meet the requirements for extracting espresso.

### SUMMARY

The object of the present disclosure is to provide a flow stabilizing valve to solve the problem of unstable water pressure in the pipeline when an existing coffee machine uses an electromagnetic pump for water supply.

The present disclosure is achieved through the following technical solutions:

A flow stabilizing valve, comprising a valve core, a valve sleeve, and a valve housing. The valve core has a water inlet, a water outlet, and a pressure stabilizing water passage extending from the water inlet to the water outlet. The valve core is disposed within the valve sleeve and cooperates with the valve sleeve to form a water chamber. The water chamber surrounds the pressure stabilizing water passage and is in fluid communication with the pressure stabilizing water passage. The valve sleeve is disposed within the valve housing and cooperates with the valve housing to form an air chamber surrounding the water chamber. The valve sleeve is capable of elastic deformation. When water flows from the pressure stabilizing water passage into the water chamber, the valve sleeve expands towards the air chamber and maintains a compressing force on the water, thereby creating a tendency for the water to flow back from the water chamber to the pressure stabilizing water passage as the valve sleeve contracts and resets.

The advantage of this technical solution lies in configuring the flow stabilizing valve with the valve core, valve sleeve, and valve housing. The valve housing and the valve sleeve form the air chamber, while the valve sleeve and the valve core form the water chamber. The valve sleeve expands or contracts and resets when the water pump is pumping or stops pumping, forming continuous responsive deformation and energy storage. This reduces variations in water flow pulsation, enabling water within the pressure stabilizing water passage to flow continuously and smoothly. Consequently, the water flow rate and pressure within the pressure stabilizing water passage become relatively stable, allowing the water pressure to meet the requirements for extracting espresso.

Further, the pressure stabilizing water passage communicates with the water chamber via flow exchange holes. The valve core has several sets of flow exchange holes, each set consisting of holes opened on opposite sides of the valve core. The several sets of flow exchange holes are arranged at intervals along with the axial direction of the valve core.

Further, the pressure stabilizing water passage is provided with a flow restricting strip between any two adjacent sets of flow exchange holes. The flow restricting strip extends around the axis of the pressure stabilizing water passage to form a flow restricting hole.

Further, a portion of the valve sleeve opposite the flow exchange holes bulges outwards, and/or a portion of the valve housing opposite the flow exchange holes bulges outwards.

Further, the valve sleeve is sleeved outside the valve core. Limiting rings are provided on the side walls at both ends along the length direction of the valve core. The limiting rings and the air chamber are spaced apart to form limiting spaces. Both ends along the length direction of the valve sleeve are respectively embedded within the two limiting spaces, tightly fitting against the corresponding limiting ring and the air chamber.

Further, a pressing ring is formed at a position in the air chamber opposite each limiting ring. The pressing ring causes the corresponding end of the valve sleeve embedded within the limiting space to tightly fit against the limiting ring. Since the valve sleeve is disposed within the valve housing and cooperates with the valve housing to form the air chamber surrounding the water chamber, the valve sleeve expands within a predetermined space (i.e., its expansion cannot exceed the size of the air chamber), preventing the valve sleeve from rupturing due to expansion.

Further, the valve housing has an inlet channel in communication with the pressure stabilizing water passage via the water inlet. The inlet channel has an inlet shoulder. The end of the valve core forming the water inlet is inserted into the inlet channel and abuts against the inlet shoulder. The valve housing has an outlet channel in communication with the pressure stabilizing water passage via the water outlet. The outlet channel has an outlet shoulder. The end of the valve core forming the water outlet is inserted into the outlet channel and abuts against the outlet shoulder.

Further, the valve housing comprises an upper housing and a lower housing. The upper housing and the lower housing are detachably and fixedly connected. The upper housing has the outlet channel, and the lower housing has the inlet channel.

To solve the problem that existing coffee machines using electromagnetic pumps for water supply result in unstable water pressure in the pipeline, making it difficult for the pipeline pressure to meet the requirements for extracting espresso, the present disclosure provides a flow stabilizing valve. Accordingly, a water flow stabilization system is provided, comprising a flow distribution pipe, a water pump, and the flow stabilizing valve. The flow distribution pipe has a flow distribution channel and a pressure relief channel. The flow distribution channel connects the water pump and the flow stabilizing valve via a flow distribution port. The pressure relief channel connects the flow distribution channel to the outside via a pressure relief port. The flow distribution channel is provided with a flow distribution switch assembly for opening and closing the flow distribution port. The pressure relief channel is provided with a pressure relief switch assembly for opening and closing the pressure relief port. The flow stabilizing valve is the aforementioned flow stabilizing valve.

Further, the flow distribution switch assembly comprises a flow distribution stop block and a flow distribution biasing spring. The flow distribution biasing spring presses against a side of the flow distribution stop block opposite the flow distribution port, causing the flow distribution stop block to block the flow distribution port. And/or, the pressure relief switch assembly comprises a pressure relief stop block and a pressure relief biasing spring. The pressure relief biasing spring presses against a side of the pressure relief stop block opposite to the pressure relief port, causing the pressure relief stop block to block the pressure relief port.

### BRIEF DESCRIPTION OF DRAWINGS

To illustrate the technical solutions in the embodiments of the present application more clearly, the following briefly introduces the drawings required for describing the embodiments. Apparently, the drawings in the following description are only some embodiments of the present application. For those of ordinary skill in the art, other drawings can be obtained based on these drawings without creative effort.

To illustrate the technical solutions in the embodiments of the present disclosure more clearly, the following briefly introduces the drawings required for describing the embodiments.

FIG. 1 is a perspective view of a water flow stabilization system disclosed in an embodiment of the present disclosure.

FIG. 2 is a cross-sectional view of the water flow stabilization system disclosed in an embodiment of the present disclosure.

FIG. 3 is a partial enlarged view of portion A shown in FIG. 2.

FIG. 4 is an exploded view of a flow stabilizing valve disclosed in the embodiment of the present disclosure.

FIG. 5 is a perspective view of a valve core in an embodiment of the present disclosure.

FIG. 6 is a cross-sectional view of a valve core in an embodiment of the present disclosure.

### DETAILED DESCRIPTION OF EMBODIMENTS

The technical solutions in the embodiments of the present disclosure will be described clearly and completely below with reference to the accompanying drawings. Obviously, the described embodiments are only a part of the embodiments of the present disclosure, not all of them. Based on the embodiments of the present disclosure, all other embodiments obtained by those of ordinary skill in the art without creative effort shall fall within the protection scope of the present disclosure.

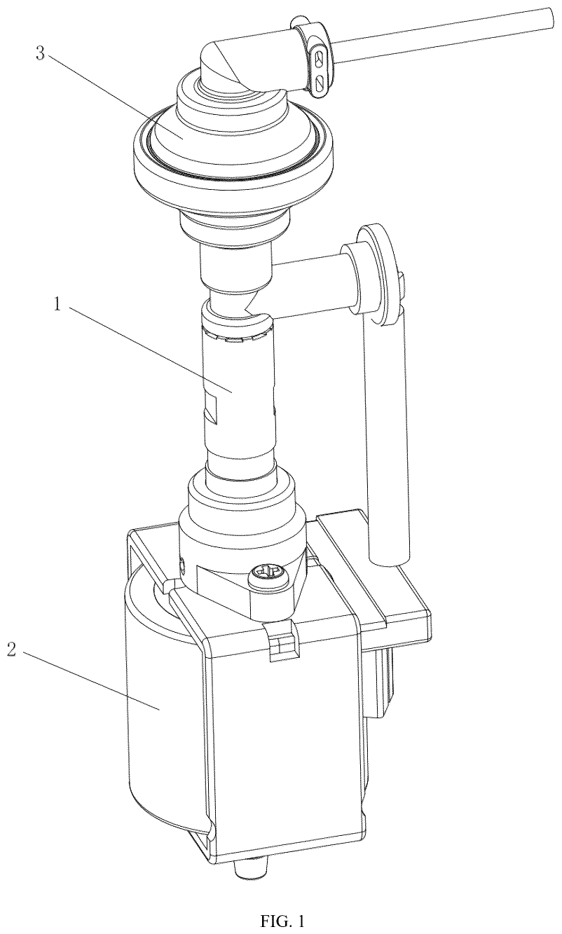

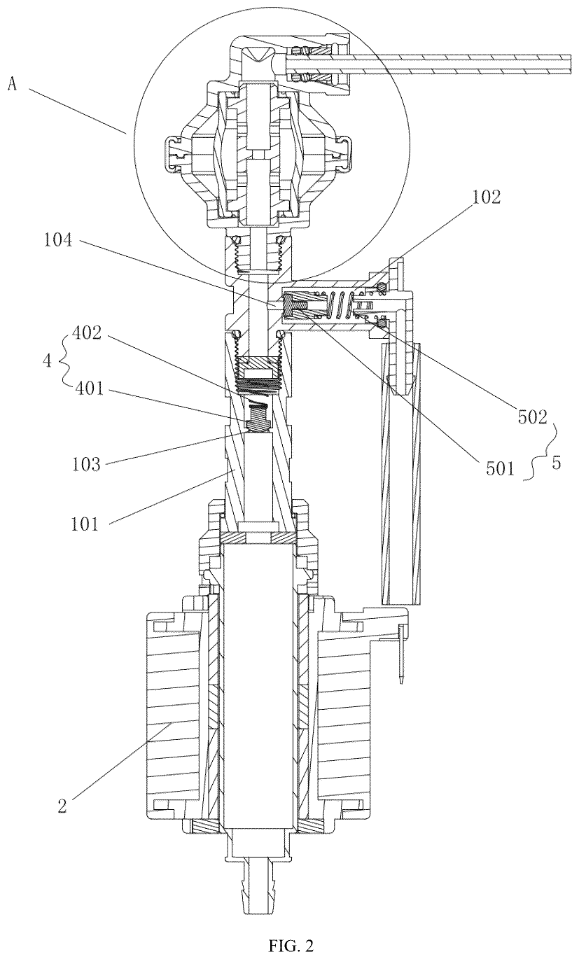

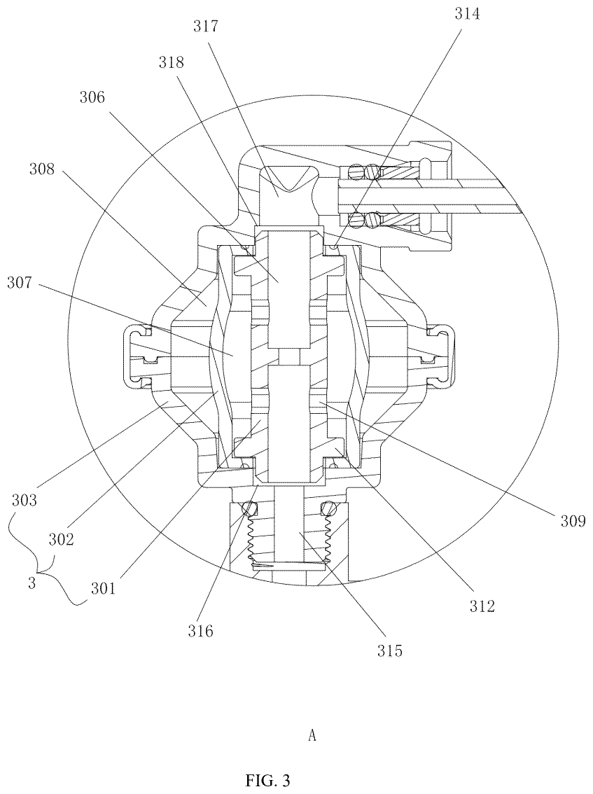

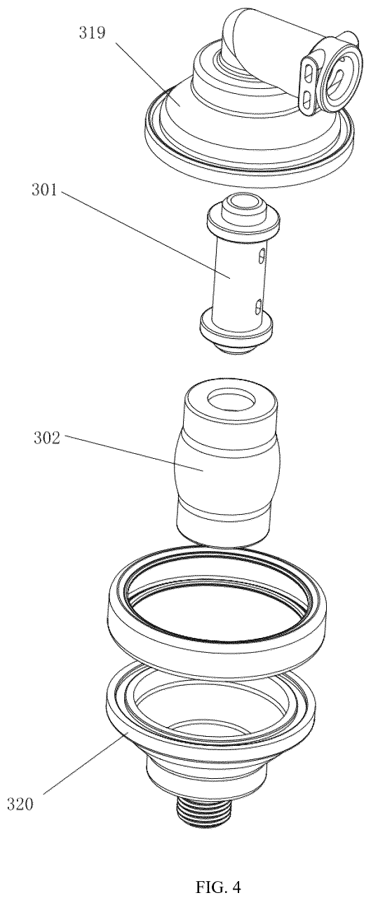

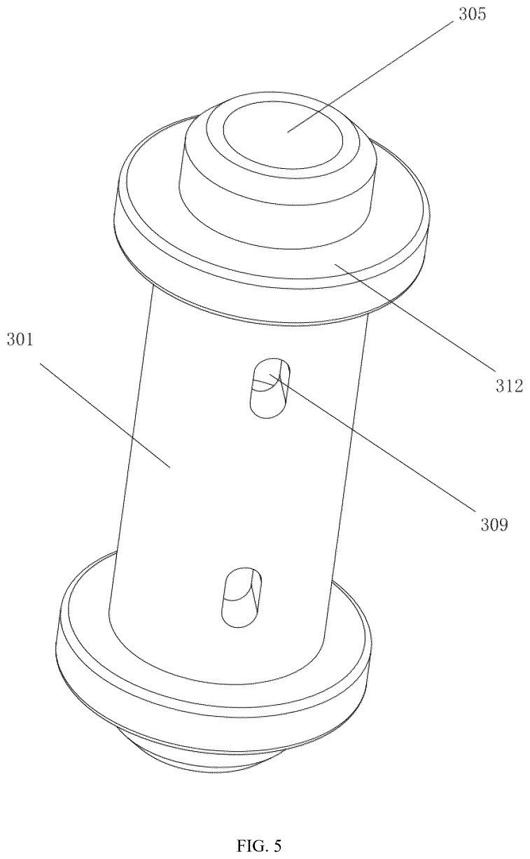

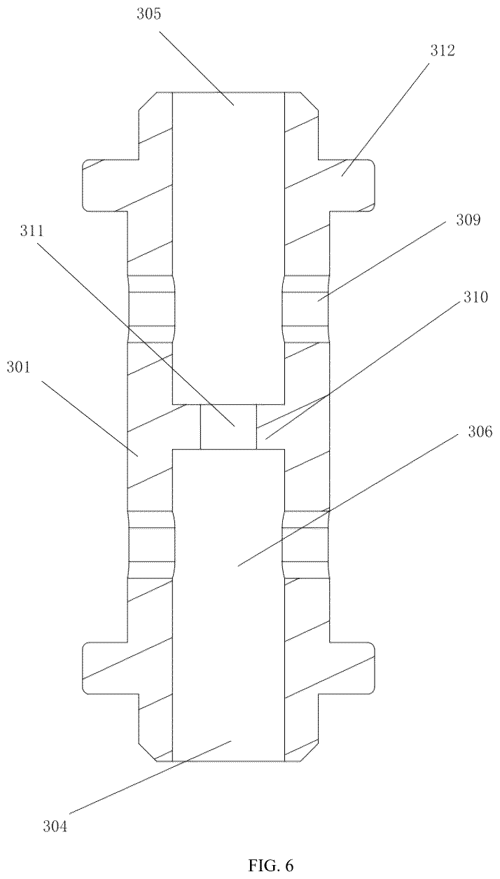

Embodiment: As shown in FIGS. 1-6, the water flow stabilization system comprises a flow distribution pipe 1, a water pump 2, and a flow stabilizing valve 3. The flow distribution pipe 1 has a flow distribution channel 101 and a pressure relief channel 102. The flow distribution channel 101 connects the water pump 2 and the flow stabilizing valve 3 via a flow distribution port 103. The pressure relief channel 102 connects the flow distribution channel 101 to the outside via a pressure relief port 104. The flow distribution channel 101 is provided with a flow distribution switch assembly 4 for opening and closing the flow distribution port 103. The pressure relief channel 102 is provided with a pressure relief switch assembly 5 for opening and closing the pressure relief port 104. The flow stabilizing valve 3 comprises a valve core 301, a valve sleeve 302, and a valve housing 303. The valve core 301 has a water inlet 304, a water outlet 305, and a pressure stabilizing water passage 306 extending from the water inlet 304 to the water outlet 305. The valve core 301 is disposed within the valve sleeve 302 and cooperates with the valve sleeve 302 to form a water chamber 307. The water chamber 307 surrounds the pressure stabilizing water passage 306 and is in fluid communication with the pressure stabilizing water passage 306. The valve sleeve 302 is disposed within the valve housing 303 and cooperates with the valve housing 303 to form an air chamber 308 surrounding the water chamber 307. The valve sleeve 302 is capable of elastic deformation. When water flows from the pressure stabilizing water passage 306 into the water chamber 307, the valve sleeve 302 expands toward the air chamber 308 and maintains a compressing force on the water, thereby creating a tendency for the water to flow back from the water chamber 307 to the pressure stabilizing water passage 306 as the valve sleeve 302 contracts and resets. When water flows from the water chamber 307 into the pressure stabilizing water passage 306, the valve sleeve 302 contracts and resets toward the pressure stabilizing water passage 306. The pressure stabilizing water passage 306 communicates with the water chamber 307 via flow exchange holes 309. The water pump 2 is an electromagnetic pump. The flow distribution switch assembly 4 comprises a flow distribution stop block 401 and a flow distribution biasing spring 402. The flow distribution biasing spring 402 presses against a side of the flow distribution stop block 401 opposite the flow distribution port 103, causing the flow distribution stop block 401 to block the flow distribution port 103. The pressure relief switch assembly 5 comprises a pressure relief stop block 501 and a pressure relief biasing spring 502. The pressure relief biasing spring 502 presses against a side of the pressure relief stop block 501 opposite the pressure relief port 104, causing the pressure relief stop block 501 to block the pressure relief port 104. The pressure relief port 104 is located between the flow distribution port 103 and the water inlet 304.

The working process of the water flow stabilization system is as follows:

When the water pump 2 supplies water, the flow distribution stop block 401 moves away from the flow distribution port 103 under the action of water pressure, overcoming the force of the flow distribution biasing spring 402. Water flows into the pressure stabilizing water passage 306 from the water inlet 304, causing the water pressure within the pressure stabilizing water passage 306 to rise. At this time, part of the water flows into the water chamber 307 through the flow exchange holes 309, causing the water chamber 307 to expand toward the air chamber 308. Another part of the water flows out from the water outlet 305. Since the expansion of the water chamber 307 toward the air chamber 308 when water flows into it through the flow exchange holes 309 reduces the water pressure within the pressure stabilizing water passage 306.

When the water pump 2 stops supplying water, the flow distribution stop block 401 closes the flow distribution port 103 under the action of the flow distribution biasing spring 402. The water pressure within the pressure stabilizing water passage 306 decreases. At this time, water in the water chamber 307 flows back into the pressure stabilizing water passage 306 through the flow exchange holes 309. Since the water chamber 307 contracts and resets toward the pressure stabilizing water passage 306 when water flows into it from the water chamber 307 through the flow exchange holes 309, the water pressure within the pressure stabilizing water passage 306 increases (i.e., achieving pressure boosting in the pressure stabilizing water passage 306).

In summary, this embodiment provides a flow stabilizing valve and its applied water flow stabilization system to solve the problem that existing coffee machines using electromagnetic pumps for water supply result in unstable water pressure in the pipeline, making it difficult for the pipeline pressure to meet the requirements for extracting espresso. This is mainly achieved by configuring the flow stabilizing valve 3 with the valve core 301, valve sleeve 302, and valve housing 303. The valve housing 303 and the valve sleeve 302 form the air chamber 308, while the valve sleeve 302 and the valve core 301 form the water chamber 307. The valve sleeve 302 expands or contracts and resets when the water pump 2 is pumping or stops pumping, forming continuous responsive deformation and energy storage. This reduces variations in water flow pulsation, enabling water within the pressure stabilizing water passage 306 to flow continuously and smoothly. Consequently, the water flow rate and pressure within the pressure stabilizing water passage 306 become relatively stable, allowing the water pressure to meet the requirements for extracting espresso. Furthermore, since the valve sleeve 302 is disposed within the valve housing 303 and cooperates with the valve housing 303 to form the air chamber 308 surrounding the water chamber 307, the valve sleeve 302 expands within a predetermined space (i.e., its expansion cannot exceed the size of the air chamber 308), preventing the valve sleeve 302 from rupturing due to expansion.

When the pressure within the flow distribution channel 101 exceeds a preset value, the pressure relief stop block 501 moves away from the pressure relief port 104 under the action of water pressure, overcoming the force of the pressure relief biasing spring 502, and water is discharged outward from the pressure relief port 104. When the pressure within the flow distribution channel 101 decreases to within the preset value, the pressure relief stop block 501 closes the pressure relief port 104 under the action of the pressure relief biasing spring 502.

In this embodiment of the present disclosure, the valve core 301 has several sets of flow exchange holes, each set consisting of holes opened on opposite sides of the valve core 301. The several sets of flow exchange holes are arranged at intervals along the axial direction of the valve core 301. Since the valve core 301 has several sets of flow exchange holes, each set consisting of holes opened on opposite sides of the valve core 301, symmetrical flow exchange between the pressure stabilizing water passage 306 and the water chamber 307 is achieved when the water pump 2 is pumping or stops pumping, resulting in excellent flow exchange performance.

In this embodiment of the present disclosure, the pressure stabilizing water passage 306 is provided with a flow restricting strip 310 between any two adjacent sets of flow exchange holes. The flow restricting strip 310 extends around the axis of the pressure stabilizing water passage 306 to form a flow restricting hole 311. Since the pressure stabilizing water passage 306 is provided with the flow restricting strip 310 between any two adjacent sets of flow exchange holes, and the flow restricting strip 310 extends around the axis of the pressure stabilizing water passage 306 to form the flow restricting hole 311, this flow restricting hole 311 serves a flow distribution function when the water pump 2 is pumping and a flow restricting function when the water pump 2 stops pumping. Therefore, the flow exchange speed between each flow exchange hole 309, which is distributed at intervals along the axial direction of the pressure stabilizing water passage 306, and the water chamber 307 becomes similar when the water pump 2 is pumping or stops pumping.

In this embodiment of the present disclosure, a portion of the valve sleeve 302 opposite the flow exchange holes 309 bulges outward. Since the portion of the valve sleeve 302 opposite the flow exchange holes 309 bulges outward, rapid water exchange between the pressure stabilizing water passage 306 and the water chamber 307 is enabled when the water pump 2 is pumping or stops pumping.

In this embodiment of the present disclosure, a portion of the valve housing 303 opposite the flow exchange holes 309 bulges outward. Since the portion of the valve housing 303 opposite the flow exchange holes 309 bulges outward, the spatial configuration of the air chamber 308 is adapted to the expansion of the water chamber 307, providing excellent adaptability.

In this embodiment of the present disclosure, the water inlet 304 and the water outlet 305 are respectively disposed at both ends along the length direction of the valve core 301. Limiting rings 312 are provided on the side walls at both ends along the length direction of the valve core 301. The limiting rings 312 and the air chamber 308 are spaced apart to form limiting spaces (not labeled in the drawings). The valve sleeve 302 is sleeved outside the valve core 301. Both ends along the length direction of the valve sleeve 302 are respectively embedded within the two limiting spaces, tightly fitting against the limiting rings 312 and the air chamber 308. Since the limiting rings 312 are provided on the side walls at both ends along the length direction of the valve core 301, the valve sleeve 302 is sleeved outside the valve core 301, and both ends along the length direction of the valve sleeve 302 are respectively embedded within the two limiting spaces and tightly fit against the limiting rings 312 and the air chamber 308, the assembly sealing between the valve core 301, the valve sleeve 302, and the valve housing 303 is excellent, preventing water in the water chamber 307 from leaking into the air chamber 308.

In this embodiment of the present disclosure, a pressing ring 314 is formed at a position in the air chamber 308 opposite each limiting ring 312. The pressing ring 314 causes the corresponding end of the valve sleeve 302 embedded within the limiting space to tightly fit against the limiting ring 312. Since the pressing ring 314 is formed at the position in the air chamber 308 opposite each limiting ring 312, and the pressing ring 314 causes the corresponding end of the valve sleeve 302 to tightly fit against the limiting ring 312, the assembly sealing between the valve core 301, the valve sleeve 302, and the valve housing 303 is excellent, preventing water in the water chamber 307 from leaking into the air chamber 308.

In this embodiment of the present disclosure, the valve housing 303 has an inlet channel 315 in communication with the pressure stabilizing water passage 306 via the water inlet 304. The inlet channel 315 has an inlet shoulder 316. The end of the valve core 301 forming the water inlet 304 is inserted into the inlet channel 315 and abuts against the inlet shoulder 316. The valve housing 303 has an outlet channel 317 in communication with the pressure stabilizing water passage 306 via the water outlet 305. The outlet channel 317 has an outlet shoulder 318. The end of the valve core 301 forming the water outlet 305 is inserted into the outlet channel 317 and abuts against the outlet shoulder 318. Since the end of the valve core 301 forming the water inlet 304 is inserted into the inlet channel 315 and abuts against the inlet shoulder 316, and the end of the valve core 301 forming the water outlet 305 is inserted into the outlet channel 317 and abuts against the outlet shoulder 318, the assembly sealing between the valve core 301 and the valve housing 303 is excellent, preventing water in the pressure stabilizing water passage 306 from leaking into the air chamber 308.

In this embodiment of the present disclosure, the valve housing 303 comprises an upper housing 319 and a lower housing 320. The upper housing 319 and the lower housing 320 are detachably and fixedly connected. The upper housing 319 has the outlet channel 317, and the lower housing 320 has the inlet channel 315. Since the valve housing 303 comprises the detachably and fixedly connected upper housing 319 and lower housing 320, assembly of the valve housing 303 with the valve core 301 and the valve sleeve 302 is quick and convenient.

It should be understood that terms such as “first,” “second,” etc., are used in the present disclosure to describe various information, but this information should not be limited to these terms. These terms are only used to distinguish information of the same type from each other. For example, without departing from the scope of the present disclosure, “first” information may also be referred to as “second” information, and similarly, “second” information may also be referred to as “first” information. Furthermore, terms indicating orientation or positional relationships such as “center,” “upper,” “lower,” “left,” “right,” “vertical,” “horizontal,” “inner,” “outer,” etc., are based on the orientation or positional relationships shown in the drawings. They are used only to facilitate the description of the present disclosure and simplify the description, rather than indicating or implying that the referred devices or elements must have specific orientations or be constructed and operated in specific orientations. Therefore, they should not be construed as limitations on the present disclosure.

As described above, one or more implementation modes are provided in combination with specific content, but it is not considered that the specific implementation of the present disclosure is limited to these descriptions. Any approximation or similarity to the method or structure of the present disclosure, or any technical deduction or substitution made under the premise of the inventive concept of the present disclosure, should be regarded as falling within the protection scope of the present disclosure.

What is claimed is:

1. A flow stabilizing valve, comprising a valve core, a valve sleeve, and a valve housing;
wherein the valve core comprises a water inlet, a water outlet, and a pressure stabilizing water passage extending from the water inlet to the water outlet; wherein the valve core is disposed within the valve sleeve and fitted with the valve sleeve to jointly form a water chamber, the water chamber surrounding the pressure stabilizing water passage and being in fluid communication with the pressure stabilizing water passage; and
wherein the valve sleeve is disposed within the valve housing and is fitted with the valve housing to jointly form an air chamber surrounding the water chamber, wherein the valve sleeve is elastically deformable and is configured, in response to water flowing from the pressure stabilizing water passage into the water chamber, to expand toward the air chamber and to maintain a compressive force on the water so as to produce a contraction restoring tendency that urges the water to flow back from the water chamber into the pressure stabilizing water passage.

2. The flow stabilizing valve as recited in claim 1, wherein the pressure stabilizing water passage is in fluid communication with the water chamber through a plurality of flow exchange holes;
wherein the valve core comprises a plurality of groups of flow exchange holes, each group of flow exchange holes being defined in opposite sides of the valve core, and wherein the plurality of groups of flow exchange holes are spaced apart along an axial direction of the valve core.

3. The flow stabilizing valve as recited in claim 2, wherein a flow restricting strip is disposed between every two adjacent groups of flow exchange holes in the pressure stabilizing water passage, and wherein the flow restricting strip extends around an axis of the pressure stabilizing water passage to form a flow restricting hole.

4. The flow stabilizing valve as recited in claim 2, wherein portions of the valve sleeve corresponding to the plurality of flow exchange holes are operative to bulge outwardly.

5. The flow stabilizing valve as recited in claim 1, wherein the valve sleeve is sleeved over the valve core, wherein a limiting ring is arranged on a side wall at each of two ends of the valve core in a length direction, wherein each limiting ring is spaced apart from the air chamber to form a limiting space, and
wherein two end portions of the valve sleeve in the length direction are respectively embedded in the limiting spaces and are tightly fitted against corresponding limiting rings and the air chamber.

6. The flow stabilizing valve as recited in claim 5, wherein a pressing ring is formed at a position of the air chamber facing each limiting ring, and wherein the pressing ring presses a corresponding end portion of the valve sleeve embedded in the corresponding limiting space tightly against the corresponding limiting ring.

7. The flow stabilizing valve as recited in claim 1, wherein the valve housing comprises an inlet channel in fluid communication with the pressure stabilizing water passage through the water inlet, the inlet channel having an inlet shoulder, and wherein one end of the valve core having the water inlet is inserted into the inlet channel and abuts against the inlet shoulder; and
wherein the valve housing further comprises an outlet channel in fluid communication with the pressure stabilizing water passage through the water outlet, the outlet channel having an outlet shoulder, and wherein one end of the valve core having the water outlet is inserted into the outlet channel and abuts against the outlet shoulder.

8. The flow stabilizing valve as recited in claim 7, wherein the valve housing comprises an upper housing and a lower housing detachably fixed to each other, wherein the upper housing comprises the outlet channel, and wherein the lower housing comprises the inlet channel.

9. A flow-stabilizing water hydrographic system, comprising a flow distribution pipe, a water pump, and a flow stabilizing valve;
wherein the flow distribution pipe has a flow distribution channel and a pressure relief channel, wherein the flow distribution channel communicates the water pump with the flow stabilizing valve through a flow distribution port, wherein the pressure relief channel communicates the flow distribution channel with an exterior through a pressure relief port;
wherein a flow distribution switch assembly configured to open and close the flow distribution port is disposed in the flow distribution channel, and wherein a pressure relief switch assembly configured to open and close the pressure relief port is disposed in the pressure relief channel;
wherein the flow stabilizing valve comprises a valve core, a valve sleeve, and a valve housing; wherein the valve core comprises a water inlet, a water outlet, and a pressure stabilizing water passage extending from the water inlet to the water outlet; wherein the valve core is disposed within the valve sleeve and fitted with the valve sleeve to jointly form a water chamber, the water chamber surrounding the pressure stabilizing water passage and being in fluid communication with the pressure stabilizing water passage; and wherein the valve sleeve is disposed within the valve housing and is fitted with the valve housing to jointly form an air chamber surrounding the water chamber, wherein the valve sleeve is elastically deformable and is configured, in response to water flowing from the pressure stabilizing water passage into the water chamber, to expand toward the air chamber and to maintain a compressive force on the water so as to produce a contraction restoring tendency that urges the water to flow back from the water chamber into the pressure stabilizing water passage.

10. The flow-stabilizing water hydrographic system as recited in claim 9, wherein the flow distribution switch assembly comprises a flow distribution stop block and a flow distribution biasing spring, the flow distribution biasing spring abutting against a side of the flow distribution stop block facing away from the flow distribution port so as to cause the flow distribution stop block to block the flow distribution port.

11. The flow stabilizing valve as recited in claim 2, wherein portions of the valve housing corresponding to the plurality of flow exchange holes are operative to bulge outwardly.

12. The flow stabilizing valve as recited in claim 2, wherein portions of the valve sleeve corresponding to the plurality of flow exchange holes are operative to bulge outwardly, and wherein portions of the valve housing corresponding to the plurality of flow exchange holes are operative to bulge outwardly.

13. The flow-stabilizing water hydrographic system as recited in claim 9, wherein the pressure relief switch assembly comprises a pressure relief stop block and a pressure relief biasing spring, the pressure relief biasing spring abutting against a side of the pressure relief stop block facing away from the pressure relief port so as to cause the pressure relief stop block to block the pressure relief port.

14. The flow-stabilizing water hydrographic system as recited in claim 9, wherein the flow distribution switch assembly comprises a flow distribution stop block and a flow distribution biasing spring, the flow distribution biasing spring abutting against a side of the flow distribution stop block facing away from the flow distribution port so as to cause the flow distribution stop block to block the flow distribution port; and wherein the pressure relief switch assembly comprises a pressure relief stop block and a pressure relief biasing spring, the pressure relief biasing spring abutting against a side of the pressure relief stop block facing away from the pressure relief port so as to cause the pressure relief stop block to block the pressure relief port.

15. The flow-stabilizing water hydrographic system as recited in claim 9, wherein the pressure stabilizing water passage is in fluid communication with the water chamber through a plurality of flow exchange holes;
wherein the valve core comprises a plurality of groups of flow exchange holes, each group of flow exchange holes being defined in opposite sides of the valve core, and wherein the plurality of groups of flow exchange holes are spaced apart along an axial direction of the valve core.

16. The flow-stabilizing water hydrographic system as recited in claim 15, wherein a flow restricting strip is disposed between every two adjacent groups of flow exchange holes in the pressure stabilizing water passage, and wherein the flow restricting strip extends around an axis of the pressure stabilizing water passage to form a flow restricting hole.

17. The flow-stabilizing water hydrographic system as recited in claim 15, wherein portions of the valve sleeve corresponding to the plurality of flow exchange holes are operative to bulge outwardly.

18. The flow-stabilizing water hydrographic system as recited in claim 9, wherein the valve sleeve is sleeved over the valve core, wherein a limiting ring is arranged on a side wall at each of two ends of the valve core in a length direction, wherein each limiting ring is spaced apart from the air chamber to form a limiting space, and
wherein two end portions of the valve sleeve in the length direction are respectively embedded in the limiting spaces and are tightly fitted against corresponding limiting rings and the air chamber.

19. The flow-stabilizing water hydrographic system as recited in claim 18, wherein a pressing ring is formed at a position of the air chamber facing each limiting ring, and wherein the pressing ring presses a corresponding end portion of the valve sleeve embedded in the corresponding limiting space tightly against the corresponding limiting ring.

20. The flow-stabilizing water hydrographic system as recited in claim 9, wherein the valve housing comprises an inlet channel in fluid communication with the pressure stabilizing water passage through the water inlet, the inlet channel having an inlet shoulder, and wherein one end of the valve core having the water inlet is inserted into the inlet channel and abuts against the inlet shoulder; and
wherein the valve housing further comprises an outlet channel in fluid communication with the pressure stabilizing water passage through the water outlet, the outlet channel having an outlet shoulder, and wherein one end of the valve core having the water outlet is inserted into the outlet channel and abuts against the outlet shoulder.
